(19) United States
(12) Patent Application Publication
(10) Pub. No.: US 2011/0033831 A1
(43) Pub. Date: Feb. 10, 2011

(54) METHOD AND APPLIANCE FOR DISTRACTION FROM AN UNWANTED IMPULSE

(76) Inventor: SHANY GALIANI-DORON, Pardessia (IL)

Correspondence Address: DANIEL J SWIRSKY, 55 REUVEN ST., BEIT SHEMESH, 99544, IL

(21) Appl. No.: 12/852,600

(22) Filed: Aug. 9, 2010

(30) Foreign Application Priority Data
Aug. 10, 2009 (IL) IL 200307

(51) Int. Cl. G09B 19/00

(52) U.S. Cl. 434/236

(57) ABSTRACT

Apparatus for distracting a user from an unwanted impulse, such as an impulse to eat, having an elastic bracelet to be stretched and then released at once upon feeling the unwanted impulse by the user, thereby snapping the user, resulting in causing pain to the user, thereby distracting the user from the impulse. The stretching may be carried out each time to the same level. The level may be indicated by an indicator capable of registering only a certain stretching level of the bracelet. The stretching may be to any desired level. The stretching level may be determined using a gauge.

### FIELD OF THE INVENTION

The present invention relates to the field of addictions, especially weight-loss dieting. More particularly, the invention relates to a method and appliance for distraction from an unwanted impulse.

### BACKGROUND OF THE INVENTION

Dieting is the practice of ingesting food in a regulated fashion in order to achieve or maintain a controlled weight. Most diets are geared toward weight reduction for those who are overweight or obese (or perceive themselves to be so). However, certain individuals, notably athletes, “diet” with the goal of gaining weight (usually adding muscles). Particular diets are also employed for maintaining a stable body weight.

There are innumerable special diets, such as those for weight-loss, for athletes, for individuals suffering from underweight, for body shaping, specific nutritional requirements, and so on.

Weight-loss diets restrict the intake of specific foods, or food in general, to reduce body weight. What works to reduce body weight for one person will not necessarily work for another, due to metabolic and lifestyle differences.

There are a variety of diets and dieting methods, but most people find it difficult to maintain significant weight loss over time. Among individuals that have lost 10% or more of their body weight, only some 20% are able to maintain that weight loss for a full year or more.

It is an object of the present invention to provide a technology that helps an individual fight with unwanted impulse, such as of eating and smoking.

Other objects and advantages of the invention will become apparent as the description proceeds.

### SUMMARY OF THE INVENTION

In one aspect, the present invention is directed to an apparatus for distracting a user from an unwanted impulse, such as the impulse to eat, smoke, and so on. The apparatus comprises an elastic bracelet (22), to be stretched and then released at once upon feeling the unwanted impulse by the user, thereby snapping the user, resulting with causing pain to the user, thereby distracting the user from the impulse.

The apparatus may further comprise an indicator, for indicating whether the bracelet is stretched to a certain level. For example, the indicator is an impression of a shrunken symmetrical form (34), wherein the shrinking thereof is perpendicular to the stretching direction of the bracelet. This embodiment is illustrated, for example, in FIGS. 4a and 4b.

The impression may be an etching, a niche, a print, and so on.

The apparatus may further comprise a gauge for metering the stretching level of the bracelet, thereby allowing the user to select a desired snapping intensity. For example, the gauge comprises one or more groups of symmetric shrunken forms, each form of a group being shrunk to a different level relative to the position of the form in the group. This embodiment is illustrated in FIGS. 5a and 5b.

The symmetrical forms may be a circle, square, and so on (a shrunken circle is an ellipse; a shrunken square is rectangle).

According to one embodiment of the invention, the bracelet is produced substantially from rubber, thereby achieving elasticity, but, of course, other materials may be used.

In another aspect, the present invention is directed to a method for distracting a user from impulse, the method comprising the steps of:
upon a user registering an impulse to perform an undesired operation (such as eating in certain circumstances, for fun, out of boredom, etc.), stretching an elastic bracelet wear on the user's hand; and
releasing the elastic bracelet at once, thereby snapping the hand of the user, thereby distracting the user from the undesirable impulse.

According to one embodiment of the invention, the stretching is carried out each time to the same level. The level is indicated by an indicator capable of detecting only a certain stretching level of the bracelet.

According to another embodiment of the invention, the stretching may be to any desired level. The stretching level can be determined using a gauge.

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIGS. 1 and 2 illustrate the stages for snapping a rubber bracelet, according to one embodiment of the invention.

FIG. 3 schematically illustrates an appliance for storing a plurality of rubber bracelets, according to one embodiment of the invention.

FIG. 4a schematically illustrates a rubber bracelet in a loosened state, according to one embodiment of the invention, and FIG. 4b illustrates the bracelet in a stretched state.

FIG. 5a schematically illustrates a loosened rubber bracelet, according to another embodiment of the invention.

FIG. 5b schematically illustrates the rubber bracelet of FIG. 5a, in a stretched state.

FIG. 6 is a flowchart schematically illustrating a process for distracting a user from unwanted hunger impulse.

FIG. 7 schematically illustrates a hand wearing an adjustable rubber bracelet, according to one embodiment of the invention.

It should be understood that the drawings are not necessarily drawn to scale.

### DETAILED DESCRIPTION OF THE INVENTION

The present invention will be better understood from the following detailed description of preferred embodiments, which are meant to be descriptive and not limiting. For the sake of brevity, some well-known features, methods, systems, procedures, components, circuits, and so on, are not described in detail.

The present method is based on distracting an individual, especially one maintaining a weight-loss diet regime, from an unwanted eating impulse. According to this method, whenever the individual feels a “non-planned” impulse to eat, he hurts himself by snapping his hand. As the eating desire becomes painful, the user's distraction turns from the impulse to the pain, thereby helping him overcome the desire to eat.

According to one embodiment of the invention, the way the individual hurts himself is by stretching a rubber bracelet to a certain point, and then releasing the bracelet at once. The release snaps the user's hand.

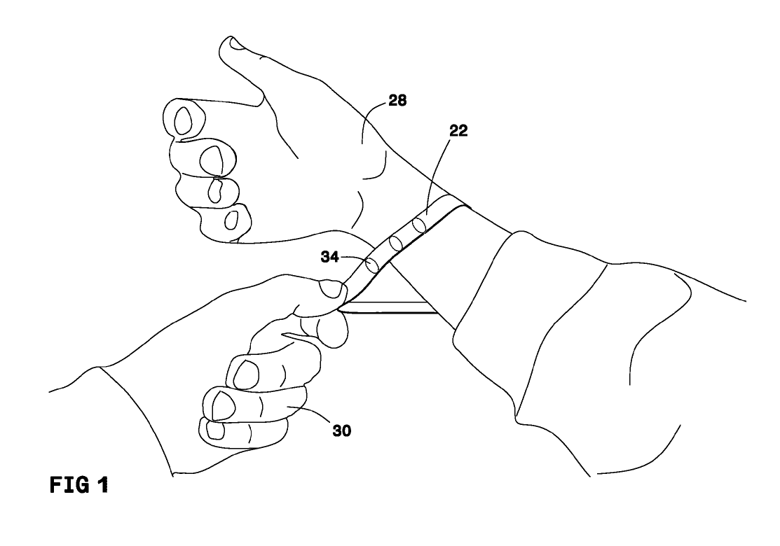

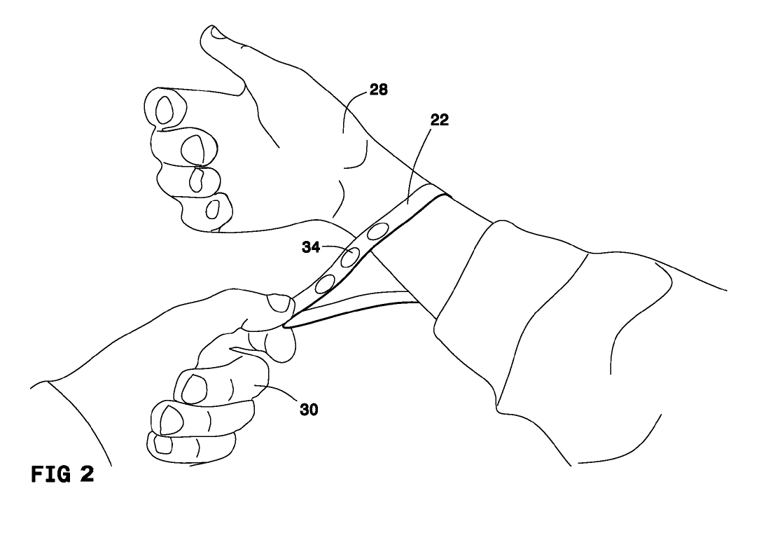

FIGS. 1 and 2 illustrate the stages for snapping a rubber bracelet, according to one embodiment of the invention.

In FIG. 1 the user stretches rubber bracelet 22, which he wears on his right hand 28, with his left hand 30, and in FIG. 2 the user releases rubber bracelet 22 at once, which snaps his right hand.

One problem of this method is how to meter the stretching, in order to avoid unexpected snapping intensity. If the user stretches the rubber bracelet beyond a certain point, the snapping may be too intensive; and if the user stretches the rubber bracelet under a certain point, the snapping may be too weak, and thereby not effective.

According to one embodiment of the invention, the required stretching is indicated by ellipses 34 impressed on the bracelet such that their wide axis is perpendicular to the stretching axis. As the rubber bracelet stretches, the ellipse form deforms, and in a certain point the ellipse looks as a circle. At this point, the user has to release the bracelet at once.

Thus, the impressed ellipses are used as an indicator for the length of the stretched bracelet, and the length of the stretched bracelet determines the snapping intensity. The ellipses allow a user to stretch the bracelet each time to the same extent, i.e., to produce the same snapping intensity each time.

Of course, the ellipse/circle is merely an example, and other symmetrical forms can be used, such as square/rectangle.

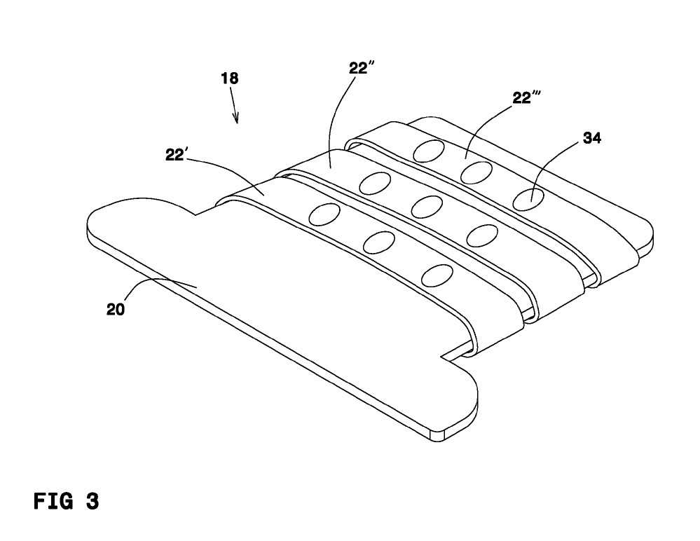

FIG. 3 schematically illustrates an appliance for storing a plurality of rubber bracelet, according to one embodiment of the invention.

The appliance, which is marked herein by reference numeral 18, comprises a core 20, made of stiff material such as cardboard, around which the rubber bracelets are wrapped. Each bracelet may be characterized by different stretching characteristics, and the characteristics may be associated with the color of the bracelet. For example, the lighter the color, the lighter the snapping of the bracelet, and vice versa.

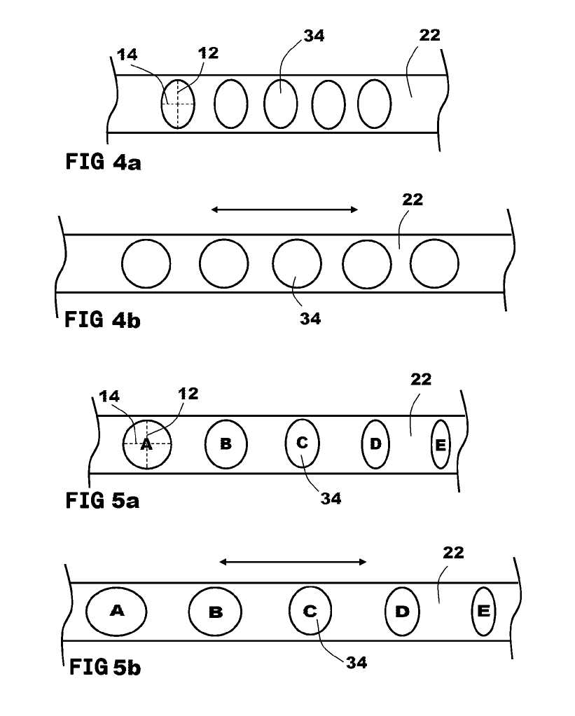

The effect of stretching a bracelet is illustrated in FIGS. 4a and 4b. FIG. 4a schematically illustrates a rubber bracelet in a loosened state, according to one embodiment of the invention, and FIG. 4b illustrates the bracelet in a stretched state.

Bracelet 22 comprises an impression of five identical ellipses 34. Each ellipse comprises a major axis 12, and a minor axis 14. The axes have been added to this figure for illustration only. They are not impressed. The orientation of minor axis 14 is the same as the stretching direction (illustrated by the arrow).

Upon stretching the bracelet, the minor axis expands, and at a certain point, as illustrated in FIG. 4b, the major axis and the minor axis have the same size, which means that each ellipse becomes a circle. At this point of stretching, the user releases the bracelet at once, thereby snapping his hand.

FIG. 5a schematically illustrates a loosened rubber bracelet, according to another embodiment of the invention.

Referring to the orientation of the illustration, according to this embodiment of the invention, the ellipses 34 have a vertical axis 12 of the same size, but the size of the horizontal axis thereof differs: the left-most ellipse (marked by the letter A) has the larger horizontal axis 14, the right-most ellipse (marked by letter E) has the smaller horizontal axis 14, and the size of the ellipses therebetween (B, C, and D) diminishes gradually.

FIG. 5b schematically illustrates the rubber bracelet of FIG. 5a, in a stretched state. As the stretch is greater, the horizontal axis 14 of the ellipses expands. As the bracelet stretches, one of the ellipses (ellipse B in the illustration) forms a circle. If the stretching continues, the next ellipse to form a circle is ellipse C. Actually, at a certain point in time, only one ellipse may have the form of a circle.

Thus, the gradually increasing ellipses are used as metering means (gauge) for the stretching, for the extent of the bracelet, and for the snapping intensity when releasing the bracelet at once.

The impression of the letters inside the ellipses is for identifying the ellipses. Actually, a bracelet may have an impression of a plurality of increasing ellipse series, and the user may indicate the required stretching by the number of the circle in a group of ellipse (e.g., the third ellipse from left).

The techniques for metering the stretching are merely examples, and those skilled in the art will appreciate that other metering techniques may be used for the same purpose.

Also, the use of rubber is merely an example for elastic material, and those skilled in the art will appreciate that other elastic materials may also be used for the same purpose.

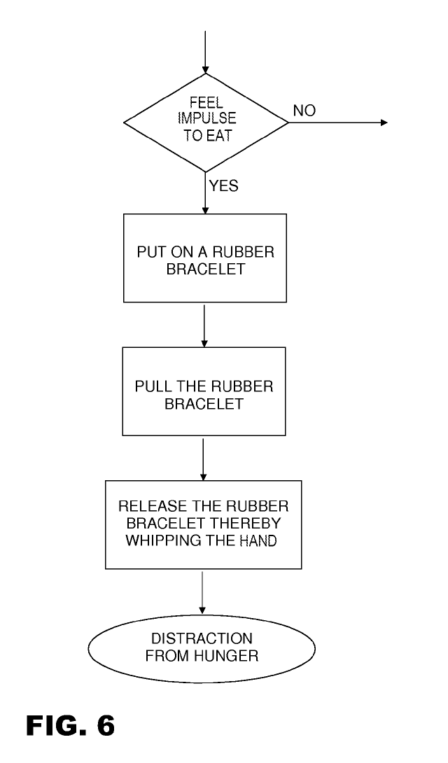

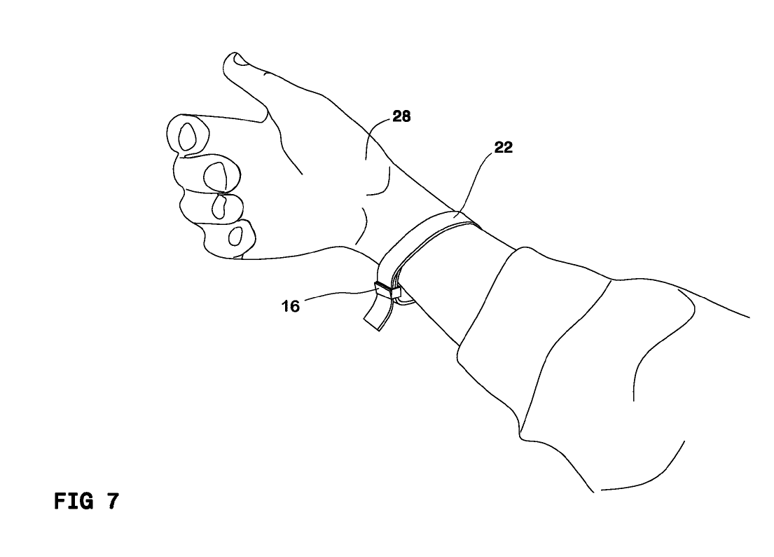

FIG. 6 is a flowchart schematically illustrating a process for distracting a user from unwanted hunger impulse.

Upon feeling the desire to eat, the user puts a rubber bracelet on his hand, pulls it, thereby stretching the bracelet to a certain degree, and then releases the bracelet at once, which results in snapping the user's hand. The pain caused by the snap distracts his attention from the urge to eat.

Of course, the technique illustrated herein may be used also for other forms of “bad” habits, such as smoking.

FIG. 7 schematically illustrates a hand wearing an adjustable rubber bracelet, according to one embodiment of the invention.

In this figure, an elastic bracelet 22 employs a fastener 16, for adjusting the extent of the bracelet. Such a mechanism is common in watches. By adjusting the extent of the bracelet, the user thereof can adjust the level of the snap caused upon stretching and releasing at once the bracelet.

In the figures and/or description herein, the following reference numerals have been mentioned:
numeral 12 denotes the major axis of an ellipse;
numeral 14 denotes the minor axis of an ellipse;
numeral 16 denotes a fastener, for adjusting the size of bracelet 22;
numeral 18 denotes an appliance for storing rubber bracelet(s);
each of numerals 22, 22′, 22″ and 22′″ denotes an elastic bracelet, such as a rubber bracelet;
numeral 28 denotes the right hand of a user;
numeral 30 denotes the left hand of a user; and
numeral 34 denotes an impression of a symmetrical form on the rubber bracelet.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. An apparatus for distracting a user from an unwanted impulse, said apparatus comprising:
an elastic bracelet, to be stretched and then released at once upon feeling said unwanted impulse by said user, thereby snapping said user, resulting with causing pain to said user, thereby distracting said user from said impulse.

2. An apparatus according to claim 1, further comprising an indicator, for indicating whether said bracelet is stretched to a certain level.

3. An apparatus according to claim 2, wherein said indicator is an impression of a shrunken symmetrical form, wherein the shrinking thereof is perpendicular to the stretching direction of said bracelet.

4. An apparatus according to claim 3, wherein said symmetrical form is a circle.

5. An apparatus according to claim 3, wherein said symmetrical form is a square.

6. An apparatus according to claim 1, further comprising a gauge for metering the stretching level of said bracelet, thereby allowing said user to select a desired snapping intensity.

7. An apparatus according to claim 6, wherein said gauge comprises one or more groups of symmetrical and shrunken forms, each form of a group being shrunk to a different level relatively to the position of said form in the group.

8. An apparatus according to claim 7, wherein said symmetrical form is a circle.

9. An apparatus according to claim 7, wherein said symmetrical form is a square.

10. An apparatus according to claim 1, wherein said bracelet is produced substantially from rubber, thereby achieving elasticity.

11. An apparatus according to claim 1, further comprising a fastener, for adjusting the extent of said bracelet.

12. A method for distracting a user from an undesirable impulse, the method comprising the steps of:
upon feeling by said user an impulse to perform an undesired operation, stretching an elastic bracelet worn on said user's hand; and
releasing said elastic bracelet at once, thereby snapping the hand of said user,
thereby distracting said user from said impulse.

13. A method according to claim 12, wherein said stretching is carried out each time to the same level, said level being indicated by an indicator capable of detecting only a certain stretching level of said bracelet.

14. A method according to claim 12, wherein said stretching is carried out each time to a desired level, wherein said desired level is determined by the user.
